(19) United States
(12) Patent Application Publication
(10) Pub. No.: US 2003/0204737 A1
(43) Pub. Date: Oct. 30, 2003

(54) Method for secreting a portable disk drive

(76) Inventors: Chee-Horng Lee, Hsinchu (TW); Lung-Yi Kuo, Taichung Hsien (TW); Yung-Hao Chang, Taichung (TW)

Correspondence Address: SUPREME PATENT SERVICES, POST OFFICE BOX 2339, SARATOGA, CA, 95070, US

(21) Appl. No.: 10/133,758

(22) Filed: Apr. 25, 2002

(51) Int. Cl. G06F 12/14

(52) U.S. Cl. 713/193

(57) ABSTRACT

A method is provided for secreting a disk drive and keeping it portable, in which the disk drive is connected with a host computer via a USB interface and comprises at least a microprocessor and a memory unit storing a state parameter and a preset code.

### FIELD OF THE INVENTION

This invention relates generally to portable disk drives, particularly to a portable USB disk drive communicable with a host computer via a Universal Serial Bus (USB) interface.

### BACKGROUND OF THE INVENTION

A USB disk drive is a portable disk drive communicable, with a host computer via a USB interface. It is an important issue pending improvements, that is confidential data stored in a USB disk drive could probably be divulged in case the disk drive is lost or stolen.

A measure taken for secreting a USB disk drive so far is to install a specified driver or application program in a host computer for driving the disk drive, whereas such a framework shall result the portability of the USB disk drive in vain.

The primary objective of this invention is to provide a secreted portable disk drive having a USB interface.

In order to realize above said objective, this invention is to provide a method for secreting a portable disk drive comprising: a step for connecting the portable disk drive with a host computer via the USB interfaces; a step for a microprocessor to read the state parameter of a memory unit and judge whether the state is under a confidential state or not, if positive, go changing an original USB mass storage descriptor into a USB communication descriptor or Exit otherwise; a step for a user to input a code to the host computer, then transmit the same to the portable disk drive via the USB interface; a step for the microprocessor to compare the code with a preset code, if correct, go disconnecting the power source, a pull-up resistor; and a data signal line, or return to the previous step otherwise; and a step to reset the descriptor of the disk drive to become a USB mass storage descriptor and to rebuild the connection among the power source, the pull-up resistor; and the data signal line.

For more detailed information regarding advantages or features of this invention, at least an example of preferred embodiment will be fully described below with reference to the annexed drawings.

### BRIEF DESCRIPTION OF THE DRAWINGS

The related drawings in connection with the detailed description of this invention to be made later are described briefly as follows, in which:

FIG. 1 shows the system framework of this invention; and

FIG. 2 shows the flowchart of a method of this invention.

### DETAILED DESCRIPTION OF THE INVENTION

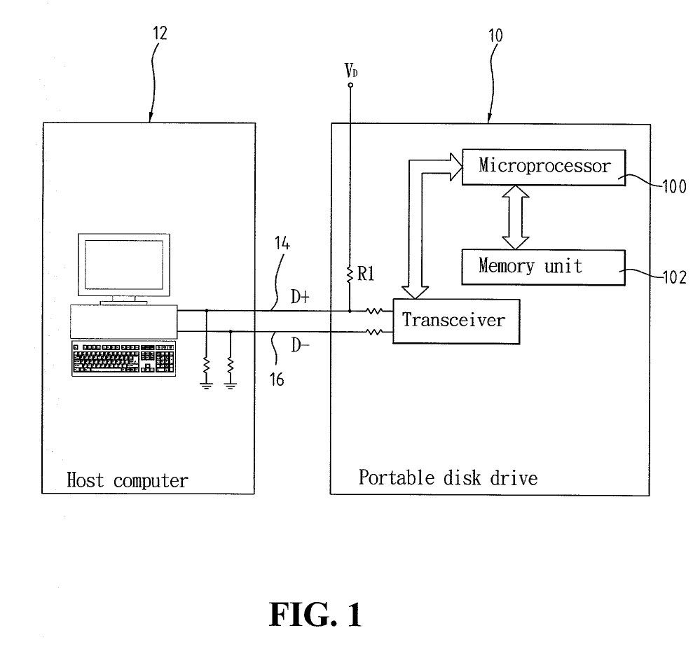

As indicated in the system framework of this invention shown in FIG. 1, a portable disk drive 10 is connected to a host computer 12 via a Universal Serial Bus (USB) interface, hence the portable disk drive 10 is considered a USB disk drive. The USB interface is provided with, in addition to a +5V, power source and the ground contact, a pair of differential data signal lines, namely a D+ and a D− data signal line 14, 16. The portable disk drive 10 mainly comprises a microprocessor 100; a pull-up resistor R1 in connection with power V_{D} and the D+ data signal line 14 and a memory unit 102 for storing a state parameter and a preset code, in which the power V_{D} is ranged from 3.0V to 3.6V; the resistance of the resistor R1 is usually 1500 Ω; the state parameter is employed for recording if the portable disk drive 10 is under a confidential state or not; and the preset code is a set of numbers predetermined by the user.

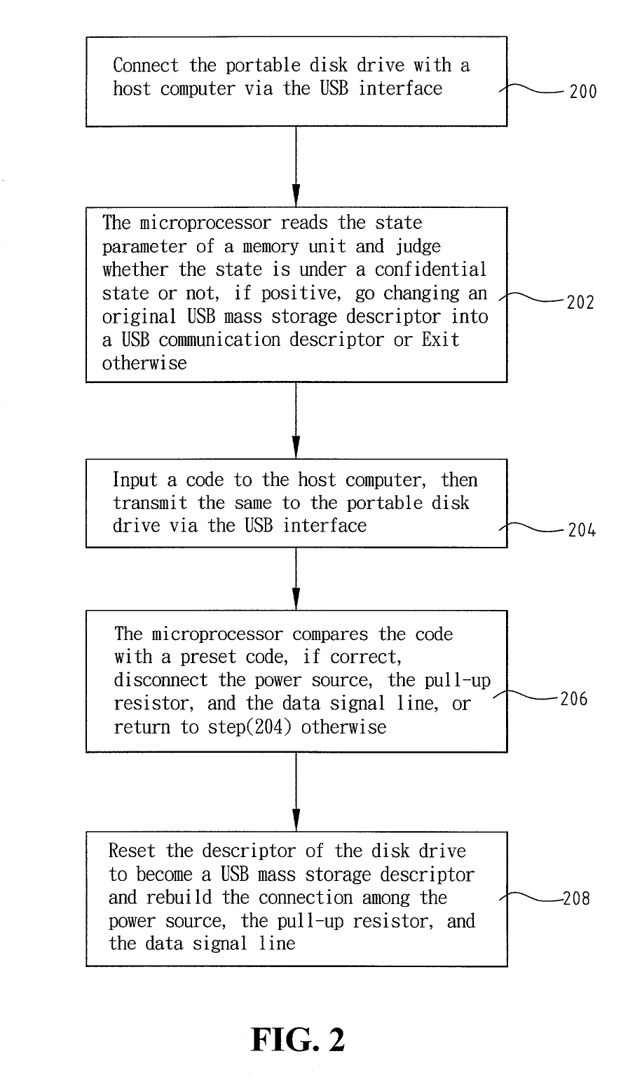

According to the flowchart shown in FIG. 2, a method of this invention for secreting a portable disk drive comprises the following steps:

A step 200 is to connect the portable disk drive 10 with a host computer 12 via the USB interface.

A step 202 is for the microprocessor 100 to read the state parameter of the memory unit 102 and thereby judge whether the state is under a confidential state or not, if positive, go changing an original USB mass storage descriptor into a USB communication descriptor. Then, the host computer 12 would request the portable disk drive 10 for the communication descriptor and thereby take the disk drive 10 as a communication device instead of a mass storage device and build a bi-directional communication channel between them; otherwise, Exit because the portable disk drive 10 is not under the confidential state.

A step 204 is for a user to input a code to the host computer 12, then transmit the same to the portable disk drive 10 via the USB interface.

A step 206 is for the microprocessor 100 in the portable disk drive 10 to compare the code with a preset code, if correct, go disconnecting the power V_{D}, the pull-up resistor R1, and the D+ data signal line 14 such that the host computer 12 would ostensibly regard that the portable disk drive 10 and the USB interface are disconnected though, the portable disk drive 10 is indeed still connected with the host computer 12, otherwise, the inputted code is erroneous and the procedure should return to the Step 204.

A step 208 is to reset the descriptor of the disk drive 10 to become a USB mass storage descriptor and to rebuild the connection among the power V_{D}, the pull-up resistor R1, and the D+ data signal line 14 again, such that the host computer 12 would recognize the disk drive 10 as a storage device and permit a user to employ it.

The disk dive in this invention is assumed a full-speed device, hence the pull-up resistor R1 is interpolated between the D+ data signal line 14 and the power V_{D} however that doesn't mean the only case to which this invention is applicable. As a matter of fact, the pull-up resistor R1 could be arranged between the data signal line 16 and the power V_{D} otherwise.

In short, the merits of this, invention might be summarized as the following:

Instead of installing an extra driver for code examination in prior arts, the method of this invention would take a firmware measure to have the code examined by a microprocessor itself while all a user has to do is input a code, which can achieve the security purpose without deteriorating the portability of a disk drive.

By using the electrical characteristics of the USB interface and by switching the connection state of a power source, pull-up resistor, and data signal line, the operating system of a host computer can judge if any device is connected with the USB interface.

As a disk drive is substantially a storage device, which doesn't support code input and code transmission, hence, the method of this invention misleads the host computer to regard the disk drive as a communication device and build a bi-directional communication channel by amending the descriptor thereof.

This invention is applicable not only to a host computer but also to any electronic device provided with a USB, for example, a PDA, planar computer, or notebook computer.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A method for secreting a portable disk drive, in which the portable disk drive is connected with an electronic device via a universal serial bus (USB) composed of a power cord, a ground contact and at least a data signal line, and is comprised of at least a microprocessor, a pull-up resistor in connection with a power source and the data signal line, and a memory unit storing a state parameter and a preset code, the method comprising:
(a) Connecting the portable disk drive with the electronic device via the USB interface;
(b) Using the microprocessor to read the state parameter of the memory unit and judge whether the state is under a confidential state or not, if positive, go changing an original USB mass storage descriptor into a USB communication descriptor or Exit otherwise;
(c) Inputting a code to the electronic device, then transmitting the same to the portable disk drive via the USB interface;
(d) Using the microprocessor to compare the code with a preset code, if correct, go disconnecting the power source, the pull-up resistor, and the data signal line, or return to step (c) otherwise; and,
(e) Resetting the descriptor of the disk drive to become a USB mass storage descriptor and rebuilding the connection among the power source, the pull-up resistor, and the data signal line.

2. The method according to claim 1, in which the electronic device is a host computer, or a PDA, or a planar computer, or a notebook computer, etc.

3. The method according to claim 1, in which the voltage of said power source is ranged from 3.0V to 3.6V.

4. The method according to claim 1, in which the data signal line is a D+ data signal line or a D− data signal line.

5. The method according to claim 1, in which the resistance of the pull-up resistor is 1500 Ω.
